(19) United States
(12) Patent Application Publication
(10) Pub. No.: US 2017/0042382 A1
(43) Pub. Date: Feb. 16, 2017

(54) Disposable Cutting Board Assembly

(71) Applicant: Jennifer Gromus, Wesr Babylon, NY (US)

(72) Inventor: Jennifer Gromus, Wesr Babylon, NY (US)

(21) Appl. No.: 14/826,777

(22) Filed: Aug. 14, 2015

(51) Int. Cl. A47J 47/00

(52) U.S. Cl. CPC A47J 47/005

(57) ABSTRACT

A disposable cutting board assembly for preventing bacterial cross contamination includes a cutting board that has a cutting surface and a surrounding wall. The cutting surface may have a food item placed thereon. The surrounding wall captures fluids from the food item such that the fluids are inhibited from being spread outwardly from the cutting surface. Thus, the surround wall inhibits the transfer of bacteria from the cutting board to a support surface.

### BACKGROUND OF THE DISCLOSURE

### Field of the Disclosure

The disclosure relates to cutting board devices and more particularly pertains to a new cutting board device for preventing bacterial cross contamination.

### SUMMARY OF THE DISCLOSURE

An embodiment of the disclosure meets the needs presented above by generally comprising a cutting board that has a cutting surface and a surrounding wall. The cutting surface may have a food item placed thereon. The surrounding wall captures fluids from the food item such that the fluids are inhibited from being spread outwardly from the cutting surface. Thus, the surround wall inhibits the transfer of bacteria from the cutting board to a support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a disposable cutting board assembly according to an embodiment of the disclosure.

FIG. 2 is a bottom view of an embodiment of the disclosure.

FIG. 3 is a right side view of an embodiment of the disclosure.

FIG. 4 is a top view of an embodiment of the disclosure.

FIG. 5 is a cross sectional view taken along line 5-5 of FIG. 4 of an embodiment of the disclosure.

### DESCRIPTION OF THE PREFERRED EMBODIMENT

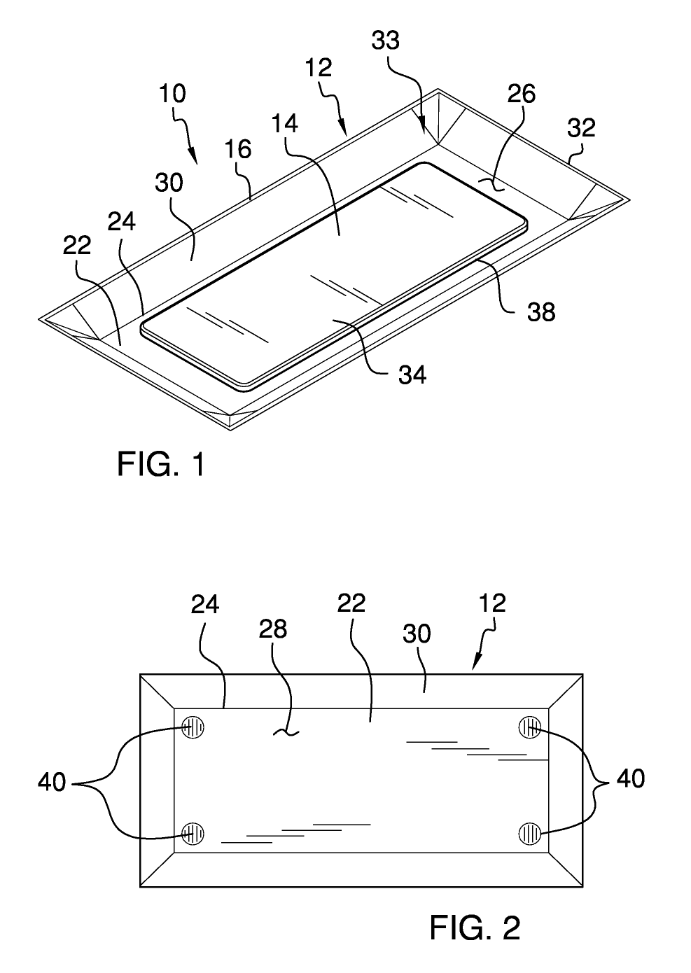

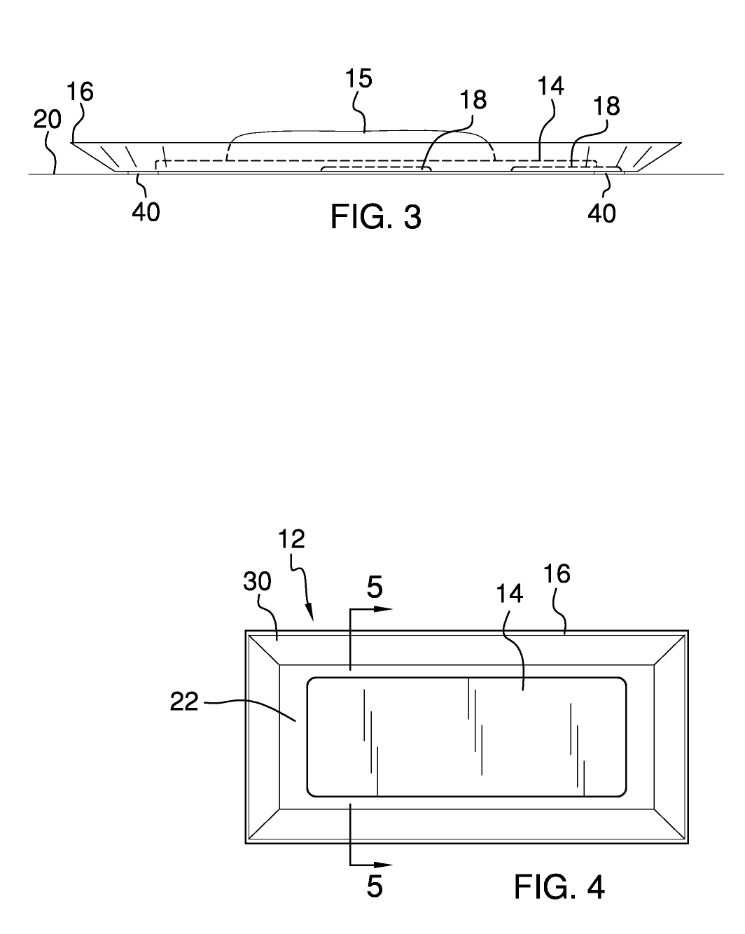

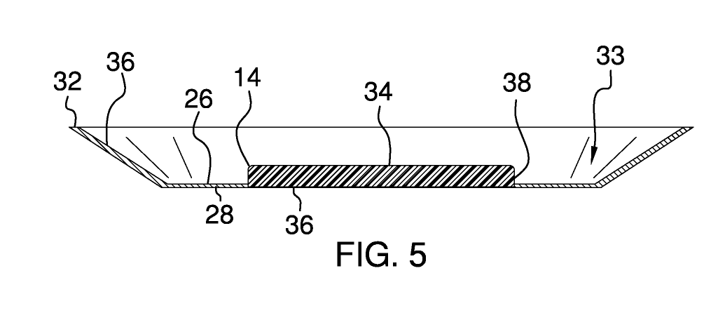

With reference now to the drawings, and in particular to FIGS. 1 through 5 thereof, a new cutting board device embodying the principles and concepts of an embodiment of the disclosure and generally designated by the reference numeral 10 will be described.

As best illustrated in FIGS. 1 through 5, the disposable cutting board assembly 10 generally comprises a cutting board 12 that has a cutting surface 14 and a surrounding wall 16. The cutting surface 14 may have a food item 15 placed thereon thereby facilitating the food item 15 to be cut. The surrounding wall 16 captures fluids 18 from the food item 15 such that the fluids 18 are inhibited from being spread outwardly from the cutting surface 14. Thus, the surrounding wall 16 inhibits the transfer of bacteria from the cutting board 12 to a support surface 20. The support surface 20 may be a table top or the like and the food item 15 may be an animal product such as chicken or the like.

The surrounding wall 16 comprises a basal side 22 that has an outer edge 24, a top surface 26 and a bottom surface 28. A perimeter side 30 extends upwardly from the top surface 26 and the perimeter side 30 is coextensive with the outer edge 24 such that the perimeter side 30 completely surrounds the basal side 22. The perimeter side 30 has a distal edge 32 with respect to the top surface 26. The perimeter side 30 angles outwardly between the top surface 26 and the distal edge 32 such that the surrounding wall 16 forms a dish 33. Thus, the surrounding wall 16 captures and retains the fluids 18.

The cutting surface 14 has an upper side 34, a lower side 36 and a peripheral edge 38 extending between the upper side 34 and the lower side 36. The lower side 36 is coupled to the top surface 26 such that the cutting surface 14 substantially covers the top surface 26. The peripheral edge 38 is spaced inwardly from the outer edge 24 of the basal side 22. The upper side 34 may have the food item 15 placed thereon and the cutting surface 14 may be comprised of a fluid impermeable material.

A plurality of feet 40 is provided. Each of the feet 40 is coupled to the basal side 22. Each of the feet 40 is positioned on the bottom surface 28. Thus, each of the feet 40 abuts the support surface 20.

In use, the food item 15 is placed on the upper side 34 of the cutting surface 14.

The food item 15 is cut into pieces and the surrounding wall 16 captures the fluids 18 released by the food item 15. Thus, the food item 15 is prevented from contaminating the support surface 20. The cutting board 12 is disposed of after the food item 15 has been cut.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A disposable cutting board assembly comprising:
a cutting board having a cutting surface and a surrounding wall, said cutting surface being configured to have a food item placed thereon, said surrounding wall being configured to capture fluids from the food item such that the fluids are inhibited from being spread outwardly from said cutting surface thereby inhibiting the transfer of bacteria from said cutting board to a support surface, said surrounding wall including
a basal side having an outer edge, a top surface and a bottom surface; and
a perimeter side extending upwardly from said top surface, said perimeter side being coextensive with said outer edge such that said perimeter side completely surrounds said basal side, said perimeter side having a distal edge with respect to said top surface, said perimeter side angling upwardly and outwardly between said top surface and said distal edge such that said distal edge has a fixed rectangular shape and said surrounding wall forms a dish.

2. (canceled)

3. (canceled)

4. The assembly according to claim 1, wherein:
said surrounding wall has a basal side, said basal side having a top surface; and
said cutting surface having an upper side, a lower side and a peripheral edge extending between said upper side and said lower side, said lower side being coupled to said top surface.

5. The assembly according to claim 4, wherein said peripheral edge is spaced inwardly from said outer edge of said basal side defining a trough configured for containing juices below said upper side of said cutting surface, said upper side being configured to have the food item placed thereon wherein said cutting surface is configured for supporting the food item above the juices collected within said trough.

6. The assembly according to claim 1, further comprising:
said surrounding wall having a basal side, said basal side having a bottom surface; and
a plurality of feet, each of said feet being coupled to said basal side, each of said feet being positioned on said bottom surface wherein each of said feet is configured to abut the support surface.

7. A disposable cutting board assembly comprising:
a cutting board having a cutting surface and a surrounding wall, said cutting surface being configured to have a food item placed thereon thereby facilitating the food item to be cut, said surrounding wall being configured to capture fluids from the food item such that the fluids are inhibited from being spread outwardly from said cutting surface thereby inhibiting the transfer of bacteria from said cutting board to a support surface, said surrounding wall comprising:
a basal side having an outer edge, a top surface and a bottom surface, and
a perimeter side extending upwardly from said top surface, said perimeter side being coextensive with said outer edge such that said perimeter side completely surrounds said basal side, said perimeter side having a distal edge with respect to said top surface, said perimeter side angling upwardly and outwardly between said top surface and said distal edge such that said distal edge has a fixed rectangular shape and said surrounding wall forms a dish;
said cutting surface having an upper side, a lower side and a peripheral edge extending between said upper side and said lower side, said lower side being coupled to said top surface, said peripheral edge being spaced inwardly from said outer edge of said basal side defining a trough configured for containing juices below said upper side of said cutting surface, said upper side being configured to have the food item placed thereon wherein said cutting surface is configured for supporting the food item above the juices collected within said trough; and
a plurality of feet, each of said feet being coupled to said basal side, each of said feet being positioned on said bottom surface wherein each of said feet is configured to abut a support surface.
